(19) United States
(12) Patent Application Publication
(10) Pub. No.: US 2018/0323027 A1
(43) Pub. Date: Nov. 8, 2018

(54) CIRCUIT BREAKER WITH PLUGGABLE TRIP MODULE

(71) Applicant: WEG DRIVES & CONTROLS - AUTOMACÃO LTDA., JARAGUA DO SUL - SC (BR)

(72) Inventors: Deivt TOMASELLI, Guaramirim - SC (BR); Douglas WEBER, Jaraguá Do Sul - SC (BR); Ricardo LUÍS PERINI, Jaraguá Do Sul - SC (BR); Ricardo SIGA DUFLOTH, Jaraguá Do Sul - SC (BR)

(73) Assignee: WEG DRIVES & CONTROLS - AUTOMACÃO LTDA., JARAGUA DO SUL - SC (BR)

(21) Appl. No.: 15/772,195

(22) PCT Filed: Nov. 6, 2015
(86) PCT No.: PCT/BR2015/050204

§ 371 Date: Apr. 30, 2018

(51) Int. Cl. H01H 71/12; H01H 71/74; H01H 71/02; H01H 83/14

(52) U.S. Cl. CPC H01H 71/125; H01H 71/74; H01H 2071/124; H01H 83/144; H01H 71/0207

(57) ABSTRACT

The present invention relates to a circuit breaker (20, 40) comprising a handle (33) connected to a switching and trip mechanism (25) in the base unit (20a), and capable of opening and closing a system (24) of electrical contacts in normal operation, ensuring the interchangeability between a pluggable electronic trip module (20b) and/or a pluggable thermomagnetic trip module (20b), using the same structural base unit (20a). The device comprises a main electric circuit “1” and a secondary circuit “2” or “2b”, wherein the main circuit “1”, using a current transformer (29) in the base unit (20a) which converts a current flowing in the main circuit “1” of the power line (23) to power the secondary circuit “2” or “2b”, issues a trip command to protect the main circuit “1”, opening the contact system (24) when predefined current limits are exceeded.

### FIELD OF THE INVENTION

The present invention relates to a circuit breaker, such as a motor protection circuit breaker or a molded case circuit breaker, used to operate as a current switch, in the monitoring and protection of power lines and motors, among others, which protects against current overloads and short-circuit, interrupting the power poles connected to an electrical circuit, comprising at least one hand-operated button, a base unit, comprising connecting terminals, interconnected to a system of electrical contacts, an arc extinguishing system, an electromagnetic safety protection system and a current transformer, among others, associated with a switching mechanism, for operating a contact system, wherein an electronic trip module or a thermomagnetic trip module, which are mechanically and electrically interchangeable with each other, equipped with a mechanical trip lever, in operation, which develops a trip command to the trip mechanism of the base unit, and open the contact system when preset current values are reached.

### BACKGROUND OF THE INVENTION

Many solutions have been developed to extend the range of settings of a circuit breaker and/or to facilitate the replacement of trip modules, in order to make the use of the same base unit more flexible, as in cases of extension of electrical circuits, due to evolution of the current system's demand to be protected, in order to allow flexibility and avoid complete replacement of the circuit breaker.

In this sense, the state of the art has shown in molded case circuit breakers the interchangeability of the trip modules, with options of different ranges of electronic adjustment modules for different current ranges and incorporations with different ranges of thermomagnetic replaceable modules. Also, in the case of circuit breakers applied to motor protection, they presented the interchangeability in the exchange of the trip modules with other different options ranges containing different electronic adjustment ranges, or still different options of ranges of thermomagnetic adjustment ranges, but it was not offered any solution that meets the possibility of using the same basis of circuit breaker, using a trip both thermomagnetic or electronic, interchangeably pluggable, without using tools and without factory preparations, which simplifies a lot the option of the user from the initial dimensioning of an electric charge, as compared to the advancement of electrical load capabilities of the equipment to be protected over time. This may allow the user, for example, to start using the circuit breaker by initially dimensioning a thermomagnetic trip module and then migrating to other thermomagnetic modules of other current ranges, or migrating to other electronic modules with additional features, allowing the user to predict a change of future demand, or additionally allowing the user to administer safety stocks of trip modules, whether thermomagnetic or electronic, and for this to be feasible, it is essential that the solution be accessible to the end user in a simple way, interchangeably and pluggable without the need to remove the circuit breaker from the place of use.

### DESCRIPTION OF THE STATE OF THE ART

One of the state of the art solutions, the U.S. Pat. No. 4,737,183 of 1976 discloses a multipole molded case circuit breaker, provided with a removable and replaceable solid-state trip unit, built with all current failure detection elements within a common housing. For each of the circuit breaker poles, the trip unit includes an input and a power supply circuit of a current transformer, mounted on a plate, disposed within the housing. The output circuit is connected to operate a permanent magnet drive mechanism for trip a mechanical lock, which normally keeps the contact operating mechanism in an initial position. The invention also taught a configuration of two transformers, used within the removable module, positioned at right angles, seeking a favorable optimization for their construction, of the size of the replaceable block. U.S. Pat. No. 4,037,183 patent and also U.S. Pat. No. 4,064,469 to 1977 presented among themselves an interchangeability in the use of both thermomagnetic and solid-state modules, however only presented a more suitable solution to molded case circuit-breakers, due to the particular fact of having in their construction the power terminals and a robust, interlocking drive and engaging mechanism, for example due to its shape being related to the distance of the poles, which restricts the module dimension with respect to the bus bars, in addition to the need to unscrew a cover for access to the modules, which are screwed.

U.S. Pat. No. 4,281,359 of 1980 discloses a solid-state trip unit, comprised of current transformer modules and a physically and electrically coupled electronic programmer module for incorporation into a molded case circuit breaker. Current Transformer Modules and solid-state trip programmer modules are presented to change the interruption current ranges and are subsequently mounted to one another. Transformers were used to convert the supply current from a replaceable electronic circuit module, but these also had a relation between the shape and distance among the poles of a molded case circuit breaker, which defines the shape of the module and transformers in relation to the power terminals.

The patent FR2583569 of 1985 featured a molded case circuit breaker including a transformer in the base, feeding replaceable solid-state trip modules using calibrated electric shunt resistors and having different ranges of trip settings, selectively mounted and expanding the available settings possibilities. It used the feature of building a molded case circuit breaker with a transformer on the base, by installing an adjustment unit, belonging to an electronic processing device that uses the signal emitted by the current transformer, where the adjustment unit has a button, which defines the adjustment range with the module inserted into a recess in the molded housing. The invention in practice has disconnected the power terminals from the construction geometry of a solid-state trip module, which follows a series of standards, due to its own insulation and sizing by current ranges, but only with electrical connection between the module and the base of the circuit breaker.

Well known in the state of the art are molded case type circuit breakers for general use, but there are other forms of construction such as those used for motor protection, where, in a different way, different solutions have also been proposed for the interchangeable modules.

The Patent DE3642719 of 1986 is quite cited in other patents of the state of the art, where is described a manually operated circuit breaker with a rotary hand lever, having an overcurrent module, which can be engaged or replaced, having a safety device with a similar cutout to a window for the manual operation lever, attached behind the manual operation lever on the edge. The manual operation lever further has a locking slide that can be moved outwardly from the end of the handle with a suspension aperture to a lock or the like, which locking slide has a locking groove that secures along a locking guide on the front side of the circuit breaker to effect the interlocking in its locked position.

The Patent EP2016605B1 of 2006 discloses a manually operated circuit breaker for motor protection and line protection, which includes a base plate, including a switching mechanism, a device of contacts, and a main current circuit. The circuit breaker includes an electronic control unit module pluggable to the base plate and configured to be defined with at least one control variable for a failure scenario so as to activate the switching mechanism by indicating an adjustable failure scenario. The electronic control unit is supplied with the main power circuit voltage. A drive unit including a power storage device is configured to activate the circuit breaker locking mechanism, and a trip element is configured to respond to an adjustable failure criterion.

Already in 2010 the patent EP2395535 teaches us a type of motor protection circuit breaker containing a thermomagnetic trip unit connected in series to the main circuit to be protected, cooperatively connected to the trip mechanism.

### OBJECT OF THE INVENTION

There are in the state of the art various means developed for equipping circuit breakers with pluggable trip modules with interchangeable thermomagnetic and/or electronic trips, however not allowing direct replacement by the user without the need to dismantle the device, as in the case of patents U.S. Pat. No. 4,037,183 or U.S. Pat. No. 4,064,469 for example, or when it has pluggable access solutions, as in the case of patents DE3642719, EP2016605 or EP2395535, offering only the replacement of an electronic trip module with another electronic similar, or a module of thermomagnetic trip for another thermomagnetic similar. In these proposals, with direct pluggable access, such as patent EP2016605, using the trip command between the electronic trip module and the base containing the switching mechanism, being made by electric signal, which restricts the trip modules only to solid-state electronic trips.

The invention therefore aims to achieve the interchangeability between thermomagnetic and/or electronic trip modules by offering modules containing different ranges of thermomagnetic ranges and/or trip modules containing different ranges of electronic adjustment ranges, being all thermomagnetic and electronic trip modules mechanically and electrically interchangeable with each other, with direct, pluggable, tool-free access to devices such as, for example, molded case circuit breakers, specific motor-protection circuit breakers and other switching devices using the same unit base.

Another object of the present invention is to reduce the dimensionality of the pluggable thermomagnetic trip modules by connecting them to the secondary terminals of a current transformer in the base unit of the circuit breaker, the primary winding of which being the same path through which the line current flows.

Another object of the present invention is to promote interchangeability between the pluggable trip modules by developing a trip command with the aid of a mechanical trip lever contained in both the thermomagnetic trip modules and the electronic trip modules to communicate with the opening trip mechanism of a contact system, contained in the base unit of the circuit breaker, as a way of unifying a trip command from the pluggable trip modules with the base unit.

Another object of the present invention is to build a circuit breaker containing pluggable trip modules, wherein the main trip mechanism of the contact system of the line to be protected is separated from said modules, i.e., all the main trip mechanics being built in the base unit, which greatly simplifies the user access to the direct exchange of these modules, without requiring a factory service or specialized workshop.

Another object of the present invention is to unlink the construction geometry and positioning of the transformer in the base unit, which can either be individually constructed per pole, common in molded case circuit breakers, or even three-phase with common core, where each phase feeds a pole of the terminals of the pluggable trip module, whether thermomagnetic and/or electronic, due to the output wiring of the transformers having lower current values and the wiring being easily shaped and adapted to be advantageously standardized, allowing grouping between the terminals from the transformer to the terminals of the trip modules, independently of the circulating current in the circuit breaker's power line, whether it is in a molded case, motor-circuit breakers or other similar switching devices.

Another object of the present invention is to allow the free use of a same pluggable trip module for an specific motor protection circuit breaker or alternatively for a molded case circuit breaker and other switching devices while maintaining the flexibility of choice between a pluggable thermomagnetic and/or electronic trip module, allowing the user to manage inventories for all compatible devices and also during manufacturing, allowing standardization of the trip modules concept for both molded case circuit breakers and motor-circuit breakers or other similar devices.

### BRIEF DESCRIPTION OF THE DRAWINGS

FIG. 1 shows a block diagram with a first preferred embodiment of the invention, wherein a circuit breaker is composed of a base unit and a pluggable electronic trip module installed in the network to be protected.

FIG. 2 shows a block diagram with a second preferred embodiment of the invention, wherein a circuit breaker comprises a base unit and a pluggable thermomagnetic trip module installed in the network to be protected.

In FIG. 3, it is shown in a perspective view a first preferred embodiment of the invention of a circuit breaker containing a pluggable thermomagnetic and/or electronic trip module.

In FIG. 4 it is shown a preferred embodiment of the invention with the base unit of the circuit breaker in the central pole, which is the object of the invention.

FIG. 4a shows a perspective view of a pluggable thermomagnetic and/or electronic trip module.

FIG. 5 shows a side view of the circuit breaker in a first preferred embodiment of the invention in partial section view, showing details of a pluggable electronic trip module.

FIG. 5a shows a detail view of the male-type connection terminals of the pluggable electronic trip module and the female-type connection terminals of the circuit breaker base.

FIG. 6 shows an exploded perspective view of the details of the pluggable electronic trip module.

FIG. 6a shows a section view of the auxiliary mechanical trip details of the pluggable electronic trip module.

FIG. 6b shows a side view of the slot details of the pluggable thermomagnetic and/or electronic trip module.

FIG. 6c shows a perspective view of the mechanical trip lever details of the pluggable electronic trip module.

FIG. 7 shows a detail view of the circuit breaker in a second preferred embodiment of the invention with a rupture showing details of the pluggable thermomagnetic trip module.

FIG. 8 shows an exploded perspective view of the details of the pluggable thermomagnetic trip module.

FIG. 8a shows a section view of the auxiliary trip mechanism details of the pluggable thermomagnetic trip module.

FIG. 8b shows a perspective view of the mechanical trip lever details of the pluggable thermomagnetic trip module.

### DETAILED DESCRIPTION OF DRAWINGS

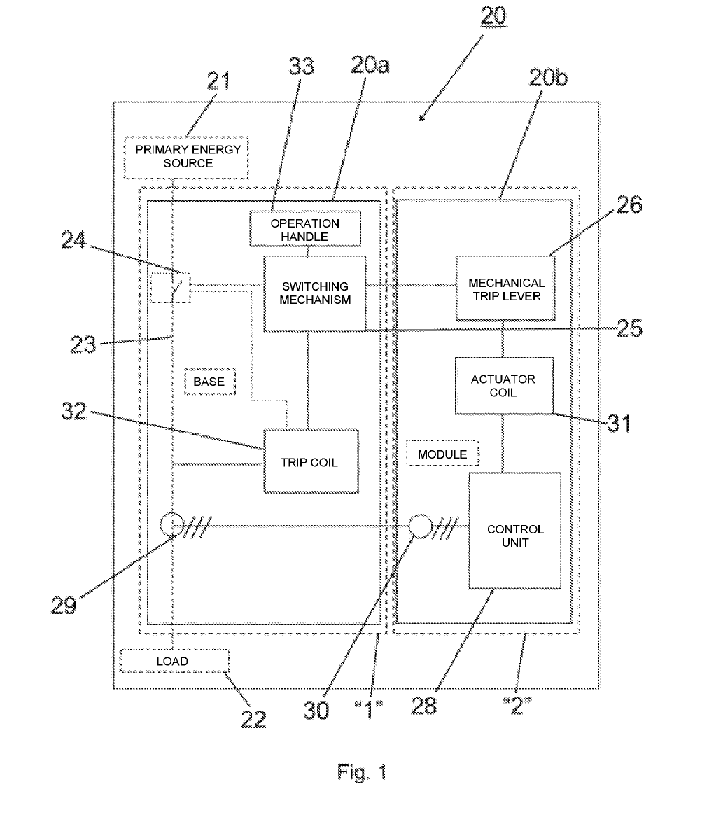

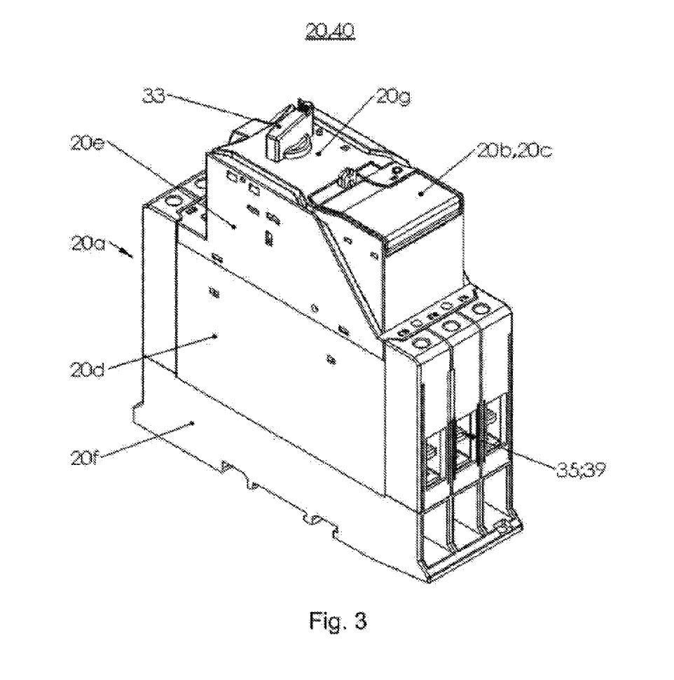

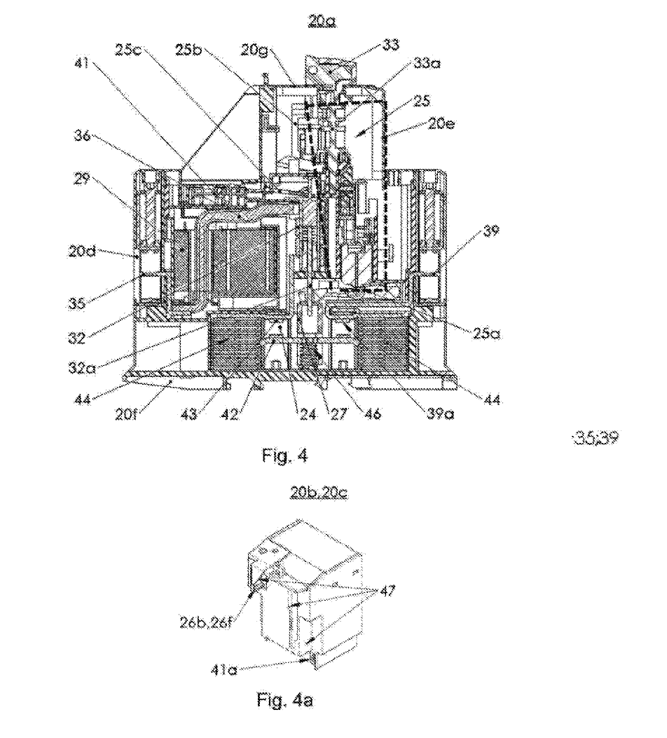

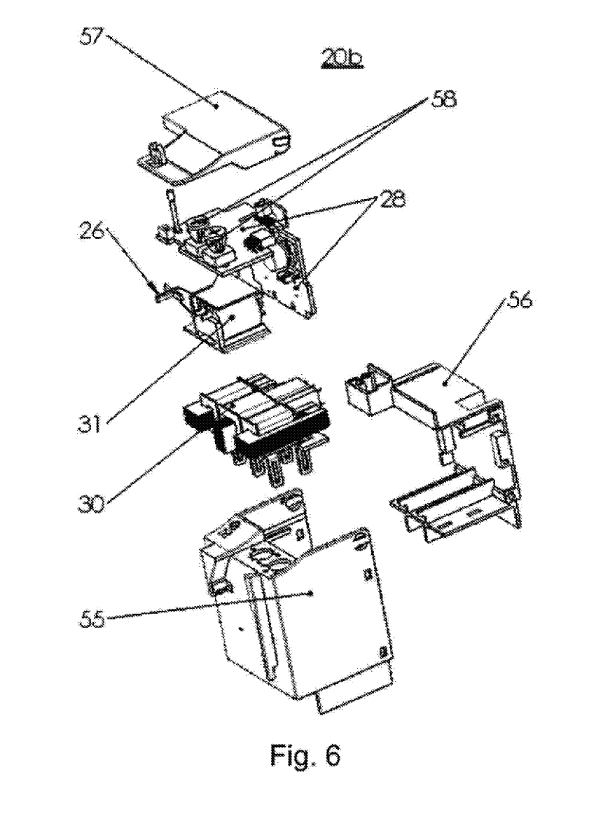

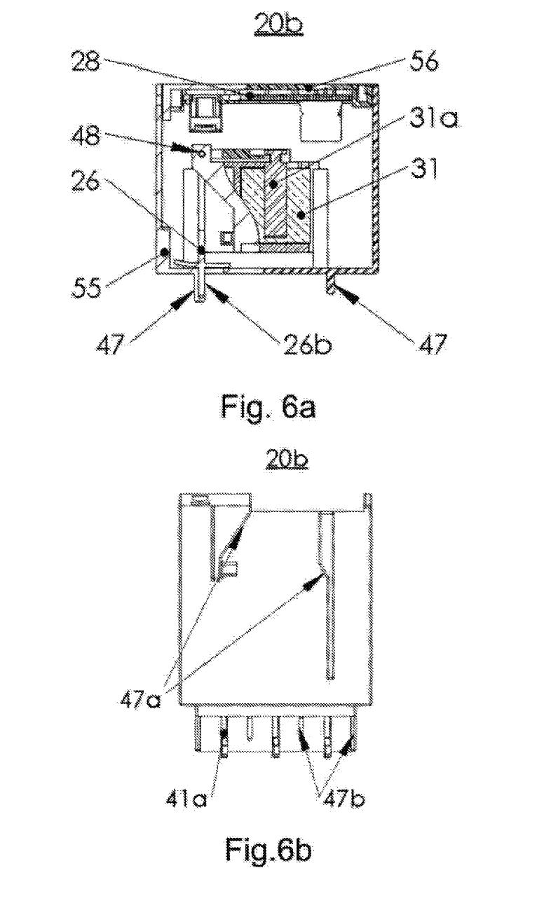

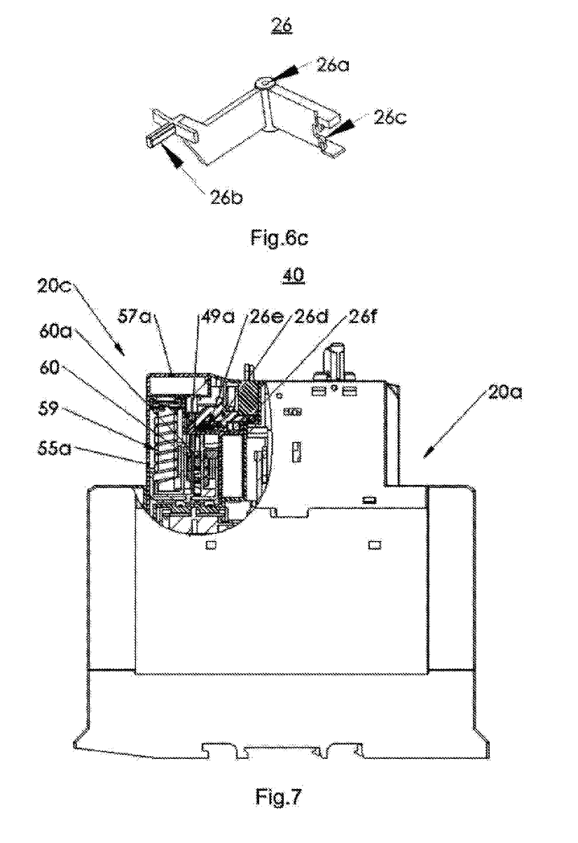

FIG. 1 shows a block diagram with a first embodiment of the invention, wherein a multipolar circuit breaker (20) connected to a primary power source (21) that provides power to a load (22), wherein on the power line (23) there between is installed said circuit breaker (20), formed by a base unit (20a), which is represented in a primary circuit “1”, and a pluggable electronic trip module (20b), which is represented in a secondary circuit “2”. The circuit breaker (20), through its base unit (20a) is connected in series to said power line (23) and to the coupled load (22), to be protected against overloads and/or short circuits. The system of electrical contacts (24) of circuit breaker (20) establishes or interrupts the current in at least one of the conductors of the power line (23), from a rotating actuator (25a) and the switching and trip mechanism (25), best observed in FIG. 4, ruled by an on/off (ON/OFF) operation handle (33), or from a trip (TRIP) for overcurrent or short-circuit, controlled by a pluggable electronic trip module (20b), wherein a solid-state circuit control unit (28) energizes a magnetic actuator coil (31), displacing the mechanical trip lever (26) and its actuator nose (26b), best seen in FIG. 6c, and the interaction lever (25b), best seen in FIG. 4, which communicate by a displacement movement with the switching and trip mechanism (25), best seen in FIG. 4, of the main circuit “1” of the base unit (20a), or directly from a magnetic actuator coil (32) of the base (20a) in the switching and trip mechanism (25), which drives a rotating actuator (25a), best seen in FIG. 4, which opens the system of electrical contacts (24). The electronic control unit (28) is powered by a first current transformer (29) in the base unit (20a), associated with at least one power line (23), wherein said current transformer (29) generates through a secondary circuit “2” an electrical signal suitable to power the pluggable electronic trip module (20b), this pluggable electronic module (20b) internally having a transformer (30) suitable to power the electronic control unit (28).

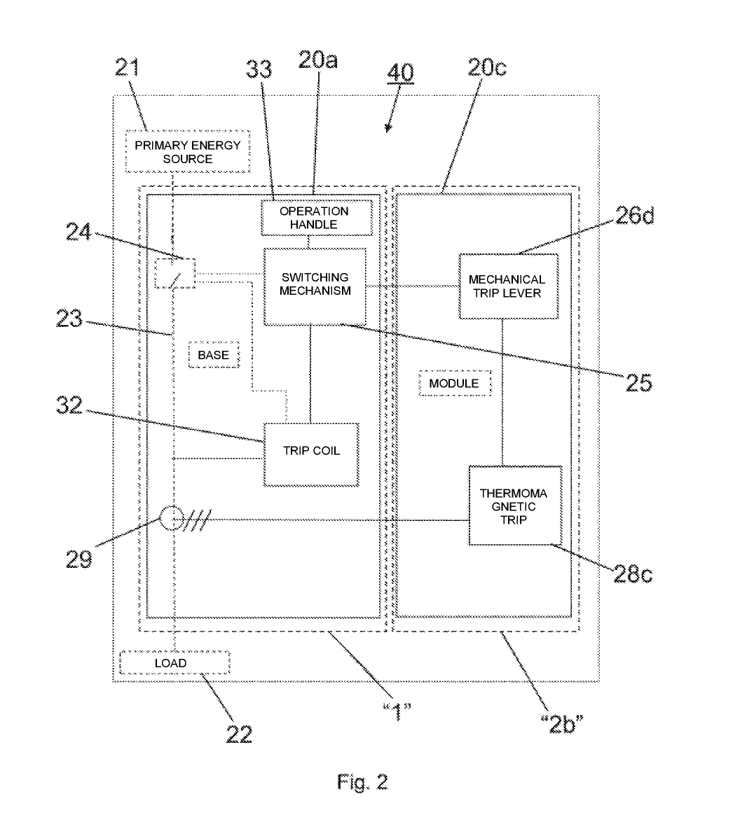

FIG. 2 shows a block diagram with a second embodiment of the invention, wherein a multipolar circuit breaker (40) connected to a primary power source (21), which provides power to a load (22), and on the power line (23) there between is installed said circuit breaker (40), formed by a base unit (20a), which is shown in a primary circuit “1” and a pluggable thermomagnetic trip module (20c), which is represented in a secondary circuit “2b”. The circuit breaker (40) through its base unit (20a) is connected in series to said power line (23) and the coupled load (22) to be protected against overloads and/or short circuits. The system of electrical contacts (24) of the circuit breaker (40) establishes or interrupts the current in at least one of the conductors of the power line (23), from a rotating actuator (25a), best observed in FIG. 4, and the switching and trip mechanism (25), better observed in FIG. 4, controlled by an on/off (ON/OFF) operation handle (33) or yet a trip (TRIP) for overcurrent or short-circuit, controlled by a pluggable thermomagnetic trip module (20c) by means of a mechanical trip lever (26d), and its actuator nose (26f) and interaction lever (25b), better observed in FIG. 4, that communicates by a displacement movement of the switching and trip mechanism (25) of the main circuit “1” of the base unit (20a), or even directly from a magnetic actuator coil (32) of the base (20a) in the switching and trip mechanism (25), which moves a rotating actuator (25a), opening the system of contacts (24). The thermomagnetic actuator (28c) is associated and powered by a current transformer (29) in the base unit (20a), connected to at least one power line (23), wherein said current transformer (29) and a primary conductor of the power line (23) generate to the secondary circuit “2b” a current suitable to supply the thermomagnetic trip module (20c) directly pluggable to it.

In FIG. 3, it is shown a perspective view of the two preferred embodiments of the invention of a circuit breaker (20,40) containing a base unit (20a), comprising a bottom face (20f), intermediate housing (20d), cover (20g), inlet and outlet terminals (35,39) and a pluggable trip module (20b,20c).

In FIG. 4 it is shown a cross-section view in the central pole of a circuit breaker (20,40), comprising the base unit (20a), being structured for a bottom face (20f), fixed to a rail (not represented), an intermediate housing (20d), a cover (20e), an on/off (ON/OFF) operation handle (33), containing a actuator shaft (33a), perpendicular to the operating face (20g), a switching and trip mechanism (25), a rotating actuator (25a), an interaction lever (25b), an auxiliary magnetic lever (25c), an input terminal (35), a shaped conductor (36) that power a safety magnetic trip coil (32), an actuator core (32a), a system of electrical contact (fixed and mobile) (24), an output terminal (39) and a current transformer (29), comprising the circuit primary “1”, where the transformer (29) of the base unit (20a) feeds a secondary circuit “2” seen in Figure “1” or a secondary circuit “2b” seen in Figure “2”, through a system of snap-connect terminals (41), further detailed in FIG. “5a”. The system of electrical contact (24) comprising a movable contact (42), a support (27), a fixed input electrical contact (43), arc extinguishing chambers (44), contact springs (46) and a fixed output contact (39a) connected to the fixed output terminal (39).

FIG. 4a shows in perspective a pluggable trip module (20b,20c) comprising connecting terminals (41a) with the base unit (20a) seen in FIG. 4, engagement rails (47) and a actuator nose (26b, 26f) of a mechanical trip lever (26, 26d) best seen in FIGS. “6c and 8b”.

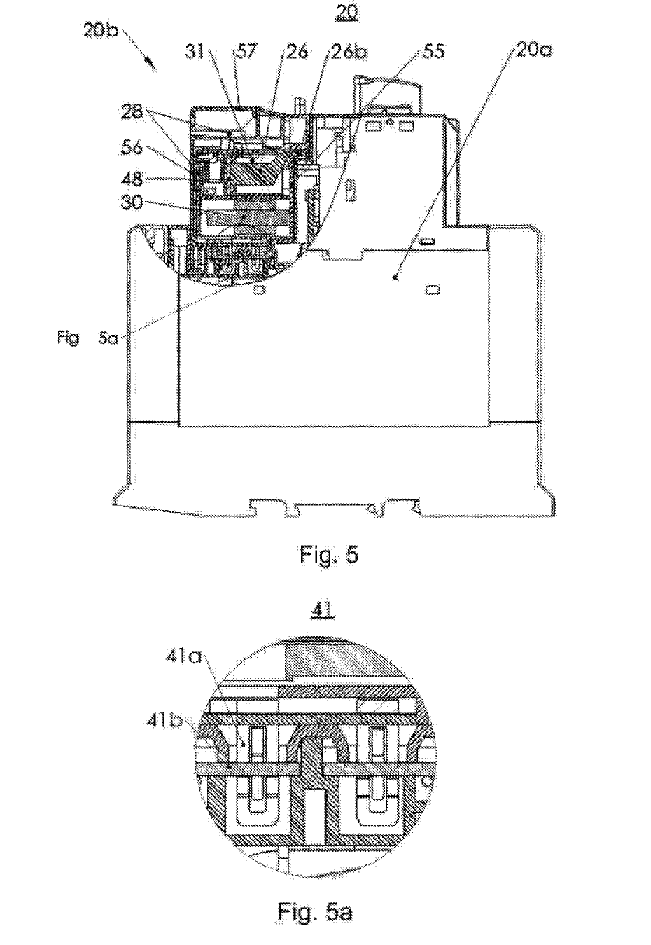

FIG. 5 shows in side view a first preferred embodiment of the invention, comprising the circuit breaker base unit (20) with a rupture, showing cutting details of the pluggable electronic trip module (20b) coupled to the base (20a), comprising a housing (55), a side cover (56), an operating interface cover (57), a second transformer (30), a mechanical trip lever (26), a actuator nose (26b), a hinge shaft (48), a magnetic actuator coil (31), a solid-state circuit control unit (28), among other components and the indication of the outline FIG. “5a” to be shown later.

FIG. 5a shows, in a larger extended cut, a snap-connect terminal system (41), comprised of a male-type terminal (41a), seen in FIG. 4a of the pluggable trip module (20b, 20c), connected to the female-type connection terminals (41b) of the base unit (20a), seen in FIG. 4.

FIG. 6 shows in an exploded perspective the details of the pluggable electronic trip module (20b) used in conjunction with the base unit (20a), forming the circuit breaker (20), comprising a housing (55), a side cover (57), a solid-state circuit control unit (28), adjustment devices (58), an auxiliary transformer (30), a magnetic actuator coil (31) and a mechanical trip lever (26).

FIG. 6a shows in a cross-section the details of the pluggable electronic trip module, comprising a housing (55), side cover (56), magnetic actuator coil (31) and magnetic core (31a), hinge shaft (48), mechanical trip lever (26), a actuator nose (26b), a solid-state circuit control unit (28) and engagement rails (47).

FIG. 6b shows in a side view the details of the plug limiter (47a) of the pluggable trip module (20b, 20c), as well as insulators (47b) between poles and connecting terminals (41a).

FIG. 6c shows in a perspective the details of the mechanical trip lever (26) of the pluggable electronic trip module (20b), seen in FIGS. 5, 6, 6a and 6b, comprising a cylindrical through hole (26a), a actuator nose (26b) and a coupling flange (26c) to the core (31a) seen in FIG. 6a.

FIG. 7 shows in a side view a second preferred embodiment of the invention, the base unit (20a) of the circuit breaker (40) with a rupture, showing section details of the pluggable thermomagnetic trip module (20c) coupled to the base (20a), comprising a housing (55a), operating interface cover (57a), a hinge axis (49a), a bimetallic rod (59), an auxiliary magnetic actuator coil (60), a magnetic actuator core (60a), a mechanical trip lever (26d), a actuator nose (26f), an auxiliary trip mechanism (26e), among other components.

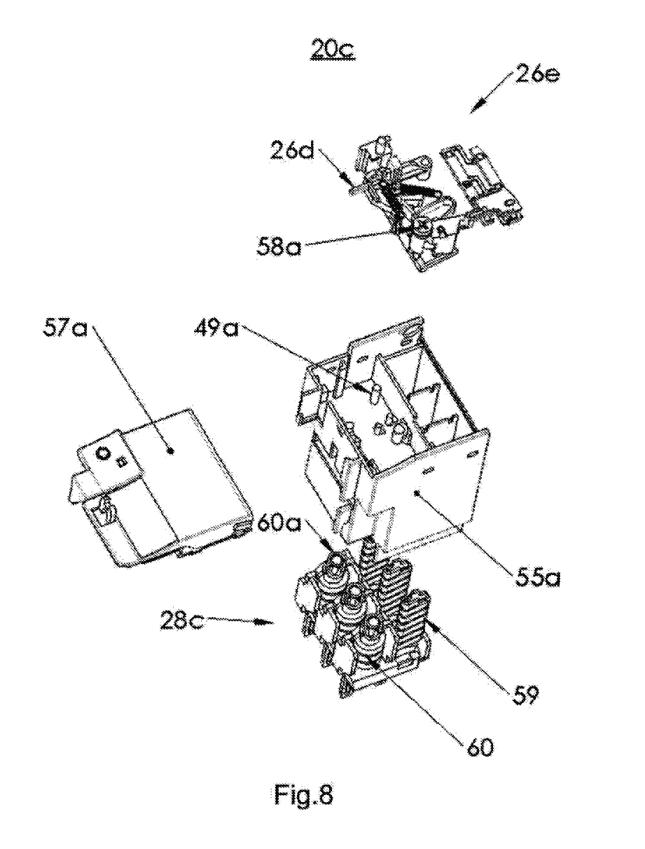

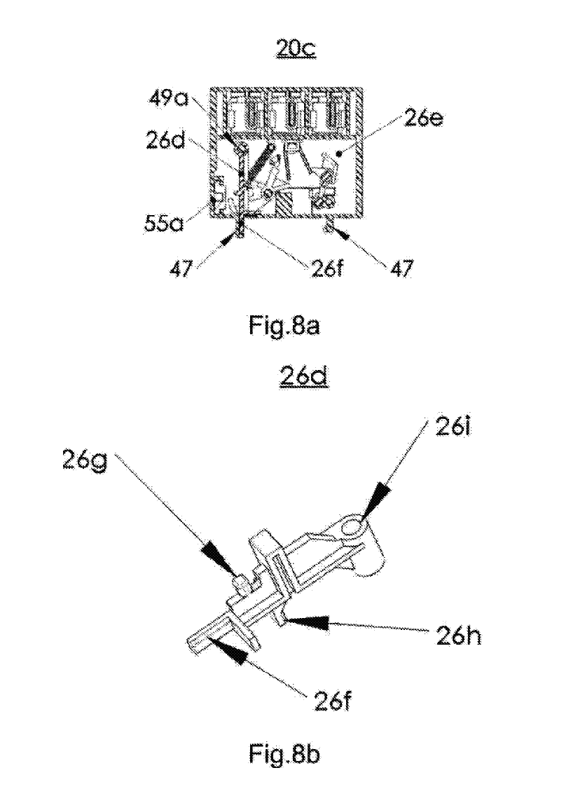

FIG. 8 shows in a exploded perspective details of the pluggable thermomagnetic trip module (20c) used to form, along with the base unit (20a), the circuit breaker (40), comprising a housing (55a), operation interface cover (57a), a hinge axis (49a), a thermomagnetic trip (28c), consisting of bimetallic rods (59), magnetic coils (60) and cores (60a), among other components and an auxiliary trip mechanism (26e), consisting of a mechanical trip lever (26d), adjustment device (58a), among other components.

FIG. 8a shows in a cross-section the details of the pluggable thermomagnetic trip module (20c), comprising a housing (55a), an auxiliary trip mechanism (26e), a mechanical trip lever (26d), a actuator nose (26f), a hinge axis (49a) and engaging rails (47).

FIG. 8b shows in perspective the details of the auxiliary mechanical trip lever (26d) of the pluggable thermomagnetic trip module (20c), comprising a through hole (26i), a actuator nose (26f), a spring locking tooth (26g) and a coupling tooth (26h).

### FUNCTIONING OF THE INVENTION

According to the invention in FIGS. 1 to 8b, a multipolar circuit breaker (20,40) is disclosed, comprising a manually operable handle (33), capable of switching on or off (ON/OFF), or yet indicate a trip (TRIP) of the circuit breaker (20,40), having a switching and trip mechanism (25) that drives a rotating actuator (25a), among other things, that opens and closes the system of electrical contacts (24) in normal operation (ON/OFF) or trip (TRIP), using the same constructive base unit (20a) which is also used for fixing the circuit breaker (20,40) to a rail or operating panel (not shown), enabling the use of a pluggable electronic trip module (20b) or the pluggable thermomagnetic trip module (20c), which are mechanically and electrically interchangeable with each other, allowing the user to simply manage the replacement of modules or adaptation of different ranges of current, to open the system of contacts (24), when predetermined current values are reached. For this, a main electrical circuit “1” and an associated secondary electrical circuit “2” or “2b” are conveniently used, where the main circuit “1” is connected in series to the bus bar of the power line (23) to be protected, through power terminals (35,39), using an associated current transformer (29) in the base unit (20a) which converts a current flowing in the main circuit “1” of the power line (23) to supply the associated secondary circuit “2” or “2b”, that comprises a pluggable trip module (20b, 20c), comprising adjustment devices (58,58a) which develops a trip command to protect the main circuit “1” through the mechanical trip lever (26,26d) and its actuator nose (26b,26f) and interaction lever (25b), that communicate by a displacement movement of the switching and trip mechanism (25) of the main circuit “1” of the base unit (20a), opening the system of contacts (24), when current pre-set limits are exceeded.

In a first preferred embodiment, in the specific case of using the pluggable electronic trip module (20b) of the diagram of FIG. 1, with the base unit (20a) of the multipolar circuit breaker (20) during the operation of the handle (33) in the on (ON) mode, wherein in any abnormality of the circulating current on the power line (23) or the load (22) being identified by the solid-state circuit control unit (28), wherein said unit (28) energizes an actuating coil (31) by displacing the magnetic core (31a), and also promoting a turning movement to the mechanical trip lever (26), seen in FIGS. 6a and 6c, through a flange (26c) of the hinge shaft (48) and hole (26a) of bearing, transferring the motion to a actuator nose (26b), which causes the interaction lever (25b) to move and actuate the switching and trip mechanism (25) and rotates the actuator (25a) and pulls the support (27) of the movable contact (42), which opens the system of contact (24) by placing the circuit breaker (20) in a trip (TRIP) position, to protect the power line (23) or its connected load (22). Additionally, the circuit breaker (20) is provided at its base unit (20a) with a trip coil (32), that in the case where any level of circulating current considered safe limitation, higher than that predicted for the operation by the pluggable electronic trip module (20b), acts with a core (32a) on an auxiliary magnetic lever (25c), which also triggers the switching mechanism (25) and rotates the actuator (25a) and pushes the support (27) of the movable contact (42), seen in FIG. 4, opening the system of contacts (24) in the base unit (20a) and stopping the flow of any conductor of the power line (23) or load (22) connected. In normal operation in the “ON” position of the handle (33), the switch and trip mechanism (25) maintains the system of contacts (24) or any other system of contacts of the base unit (20a) in a normally closed position, due to the action of the contact spring (46), wherein it is only opened by the actuating force of the switching and trip mechanism (25) when actuated by the auxiliary magnetic lever (25c), due to the motion of the core (32a) of the magnetic actuator, or the interaction lever (25b), due to the movement of the mechanical trip lever (26) or through the handle (33), connected to the switching and trip mechanism (25) by means of an shaft (33a) perpendicular to the operating face (20g) when activated by the user.

In a second preferred embodiment, in the specific case of the use of the pluggable thermomagnetic trip module (20c) with the base unit (20a) of the multipolar circuit breaker (40) in operation of the handle (33) in the (ON) mode, wherein any abnormality of the circulating current in the power line (23) or the load (22) is received by the thermomagnetic trip (28c), composed of a bimetallic rod (59), a magnetic coil (60) and a core (60a) per pole, which acts on a trip mechanism (26e) by using a spring system, which promotes a turning movement of the lever (26d), seen in FIGS. 8, 8a and 8b, where by means of the couplings (26g,26h) and the hinge axis (49a) and bearing (26i), transferring the motion the actuator nose (26f), which causes the interaction lever (25b) to move and trigger the switching and trip mechanism (25) of the base unit (20a), rotating the actuator (25a) and pushing the support (27) of the movable contact (42), seen in FIG. 4, which opens the system of contacts (24) by placing the circuit breaker (40) in a trip (TRIP) position. Additionally, the circuit breaker (40) is provided with a trip coil (32) that acts with a core (32a) on an auxiliary magnetic lever (25c), which also activates the switching and trip mechanism (25), rotates the actuator (25a) and pushes the support (27) of the movable contact (42), seen in FIG. 4, opening the system of contacts (24) in the base unit (20a) and stopping the flow of any conductor of the power line (23) or load (22) connected. In normal operation in the “ON” position of the handle (33), the switch and trip mechanism (25) maintains the system of contacts (24) or any other system of contacts of the base unit (20a) in a normally closed position, due to the action of the contact spring (46), wherein it is only opened by the actuating force of the switching and trip mechanism (25) when actuated by the auxiliary magnetic lever (25c), due to the motion of the core (32a) of the magnetic actuator or by the interaction lever (25b), due to the movement of the mechanical trip lever (26) or through the handle (33), connected to the switching and trip mechanism (25) by means of an shaft (33a) perpendicular to the operating face (20g) when activated by the user. On the operation of the bimetallic rod (59), its performance is known in the state of the art, but in a simplified way, it has more than one metallic layer, with different coefficients of expansion and, in the event of change of current (consequently increasing the temperature), the assembly bends, acting in longer periods of time, opening the system of the contacts (24) connected thereto, through the trip mechanism (26e) of the mechanical trip lever (26d) seen in FIG. 8, of the lever (25b), and the trip mechanism (25) of the base unit (20a) seen in FIG. 4, of the circuit breaker (40), seen in FIG. 3. In a similar manner, in instantaneous high current periods, the magnetic actuating coil (60) causes the core (60a) to move, also connected to the mechanism (26e) of the mechanical trip lever (26d), of the lever (25b), and the switching and trip mechanism (25) of the base unit (20a) of the circuit breaker (40) seen in FIG. 4 also opens the system of electrical contact (24).

In one exemplary embodiment of the invention, the effects of modularity between the pluggable trip modules (20b,20c) has been achieved by providing the circuit breaker (40) of a transformer (29) in the base unit (20a), which converts the flowing current, starting from a current in the power line (23) of 125 A, at a current output value of 5 A. This reduction is sufficient to allow a substantial reduction in dimensionality of the bimetallic rods (59) and magnetic actuator coils (60) connected to the pluggable thermomagnetic trip module (20c) of the circuit breaker (40) and allow better aligning of the dimensions between modules (20b) with pluggable thermomagnetic trip modules (20c). To complete the communication between the different modules, the solution provides the circuit breaker (20,40) with at least one mechanical trip lever (26,26d) between the pluggable trip modules (20b,20c) and the base unit (20a) and thereby make compatible the way the pluggable trip modules (20b, 20c) actuate the interaction lever (25b) through the mechanical trip lever (26,26d) and the switching and trip mechanism (25) of the base unit (20a), which open the system of electrical contacts (24) in the same manner, both for pluggable electronic trip modules (20b) and for pluggable thermomagnetic trip modules (20c). Yet, the invention, starting from a current in the example above 5 A, at the output of the transformer (29) of the primary circuit “1”, provides the electronic trip module (20b) of the secondary circuit “2” with a second transformer (30), which, by receiving the 5 A current from the first transformer (29) of the base unit (20a), resets the current and voltage ratio, transforming the signal and providing an output voltage at a level of 5V, suitable for the solid-state control unit (28), for example.

Unlike the state of the art contained in patents U.S. Pat. No. 4,064,469, U.S. Pat. No. 4,037,183 and the like, direct connection of the trip modules, independent of the power terminals (35,39), allows through the transformer (29) in the base unit (20a) of the circuit breaker (20, 40) that the positioning formatting of the connection terminals (41) between the pluggable trip module (20b, 20c) and the base unit (20a) for various current ranges of the power line (23) to be done in a much more flexible way, since the wiring coming out of the transformer winding can be targeted and shaped in a very practical way, keeping the geometry of the trip modules, regardless of the base unit (20a) of the circuit breaker (20, 40), power terminals (35,39), system of electrical contacts (24) and transformer (29), for example, for use in motor protection circuit breakers or also for a molded case circuit breaker or other interruption device.

Obviously, it should be understood that other modifications and variations made to this invention are considered within the scope of the present invention.

1-7. (canceled)

8. A circuit breaker having a pluggable trip module, the circuit breaker comprising:
a base unit;
a system of electrical contacts;
a switching and trip mechanism; and
a current transformer for powering the pluggable trip module, wherein the pluggable trip module is one of a pluggable electronic trip module and a pluggable thermomagnetic trip module, the pluggable electronic trip module and the pluggable thermomagnetic trip module being mechanically and electrically interchangeable with one another.

9. The circuit breaker according to claim 8, wherein the pluggable trip module is equipped with a mechanical trip lever.

10. The circuit breaker according to claim 8, wherein the base unit comprises a bottom face and a top face, and the circuit breaker comprises:
a drive shaft for driving the switching and trip mechanism, the drive shaft being perpendicular to the top face.

11. The circuit breaker according to claim 9, wherein the switching and trip mechanism comprises an interaction lever for interacting with a driving nose of the mechanical trip lever.

12. The circuit breaker according to claim 8, wherein the current transformer powers a transformer of the pluggable electronic module.

13. A circuit breaker for powering a secondary electrical circuit, the circuit breaker comprising:
a main electrical circuit comprising a main transformer configured to convert a current to power the secondary electrical circuit;
wherein the secondary electrical circuit comprises at least one of:
a pluggable electronic trip module comprising a secondary transformer and an electronic control unit; or
a pluggable thermomagnetic trip module comprising a thermomagnetic trip.
